(19) United States
(12) Patent Application Publication
(10) Pub. No.: US 2026/0292838 A1
(43) Pub. Date: Sep. 24, 2026

(54) DATA TRANSMISSION METHOD AND APPARATUS

(71) Applicant: Beijing Xiaomi Mobile Software Co., Ltd., Beijing (CN)

(72) Inventor: Xing YANG, Beijing (CN)

(73) Assignee: Beijing Xiaomi Mobile Software Co., Ltd., Beijing (CN)

(21) Appl. No.: 18/996,215

(22) PCT Filed: Aug. 4, 2022
(86) PCT No.: PCT/CN2022/110387

§ 371 Date: Jan. 17, 2025

(51) Int. Cl. H04W 72/232; H04B 7/06; H04W 72/25

(52) U.S. Cl. CPC H04W 72/232; H04B 7/06952; H04W 72/25

(57) ABSTRACT

The embodiments of the present disclosure disclose a data transmission method and apparatus, which can be applied to the technical field of communications. The method executed by a first terminal device includes receiving downlink control information (DCI) transmitted by a network-side device, the DCI being used for indicating a sidelink grant; and determining, according to the DCI, a first sidelink beam used by the sidelink grant, so as to use, on the sidelink grant, the first sidelink beam to perform sidelink transmission. Therefore, the first terminal device determines the first sidelink beam used by the sidelink grant and uses, on the sidelink grant, the first beam to transmit data to a second terminal device.

### CROSS-REFERENCE TO RELATED APPLICATIONS

The present application is a U.S. National Stage of International Application No. PCT/CN2022/110387, filed on Aug. 4, 2022, the content of which is incorporated by reference herein in its entirety.

### TECHNICAL FIELD

The present disclosure relates to the field of communication technology, and in particular to method and device for data transmission.

### BACKGROUND

In the related art, multiple logical channels can be established between terminal devices performing sidelink communication for data transmission. When a first terminal device receives a sidelink transmission resource grant (Sidelink grant), it can select a logical channel through the logical channel priority selection method (Logical Channel Prioritization, LCP), and send data to a second terminal device corresponding to the selected logical channel.

### SUMMARY

According to a first aspect, the embodiments of the present disclosure provide a data transmission method, performed by a first terminal device, including receiving downlink control information DCI sent by a network side device, where the DCI indicates a sidelink grant; and determining a first sidelink beam used by the sidelink grant according to the DCI, so as to use the first sidelink beam for sidelink transmission on the sidelink grant.

According to a second aspect, the embodiments of the present disclosure provide another data transmission method, performed by a network side device, including sending DCI for determining a first sidelink beam used by a sidelink grant to a first terminal device, where the DCI indicates the sidelink grant.

According to a third aspect, the embodiments of the present disclosure provide a communication device having some or all of the functions of realizing the first terminal device in the method described in the first aspect above. For example, the functions of the communication device may have the functions in some or all embodiments of the present disclosure, or may have the functions of implementing any one of the embodiments of the present disclosure alone. The function may be realized by hardware or by hardware executing corresponding software. The hardware or software includes one or more units or modules corresponding to the functions.

In an embodiment, the structure of the communication device may include a transceiver module and a processing module. The processor is configured to support the communication device to perform the corresponding function in the above method. The transceiver module is configured to support the communication between the communication device and other device. The communication device may further include a memory module. The memory module is configured to couple with the transceiver module and the processing module, and store necessary computer program and data for the communication device.

In an embodiment, the communication device includes a transceiver module configured to receive downlink control information DCI sent by a network side device, where the DCI indicates a sidelink grant; and a processing module configured to determine a first sidelink beam used by the sidelink grant according to the DCI, so as to use the first sidelink beam on the sidelink grant for sidelink transmission.

According to a fourth aspect, the embodiments of the present disclosure provide another communication device having some or all of the functions of realizing the network side device in the method described in the second aspect above. For example, the functions of the communication device may have the functions in some or all embodiments of the present disclosure, or may have the functions of implementing any one of the embodiments of the present disclosure alone. The function may be realized by hardware or by hardware executing corresponding software. The hardware or software includes one or more units or modules corresponding to the functions.

In an embodiment, the structure of the communication device may include a transceiver module and a processing module. The processor is configured to support the communication device to perform the corresponding function in the above method. The transceiver module is configured to support the communication between the communication device and other device. The communication device may further include a memory module. The memory module is configured to couple with the transceiver module and the processing module, and store necessary computer program and data for the communication device.

In an embodiment, the communication device includes a transceiver module configured to send DCI for determining a first sidelink beam used by a sidelink grant to a first terminal device, where the DCI indicates the sidelink grant.

According to a fifth aspect, the embodiments of the present disclosure provide a communication device, including a processor. When the processor calls a computer program in a memory, the method according to the first aspect is performed.

According to a sixth aspect, the embodiments of the present disclosure provide a communication device, including a processor. When the processor calls a computer program in a memory, the method according to the second aspect is performed.

According to a seventh aspect, the embodiments of the present disclosure provide a communication device, including a processor and a memory storing a computer program. When the processor executes the computer program stored in the memory, the method according to the first aspect is performed.

According to an eighth aspect, the embodiments of the present disclosure provide a communication device, including a processor and a memory storing a computer program. When the processor executes the computer program stored in the memory, the method according to the second aspect is performed.

According to a ninth aspect, the embodiments of the present disclosure provide a communication device, including a processor and an interface circuit. The interface circuit is configured to receive a code instruction and transmit it to the processor. The processor is configured to run the code instruction to make the device to perform the method according to the first aspect.

According to a tenth aspect, the embodiments of the present disclosure provide a communication device, including a processor and an interface circuit. The interface circuit is configured to receive a code instruction and transmit it to the processor. The processor is configured to run the code instruction to make the device to perform the method according to the second aspect.

According to an eleventh aspect, the embodiments of the present disclosure provide a random access system including the communication device described in the third aspect and the communication device described in the fourth aspect, or, alternatively, the communication device described in the fifth aspect and the communication device described in the sixth aspect, or, alternatively, the communication device described in the seventh aspect and the communication device described in the eighth aspect, or, alternatively, the communication device described in the ninth aspect and the communication device described in the tenth aspect.

According to a twelfth aspect, the embodiments of the present disclosure provide a computer-readable storage medium for storing instructions used by the first terminal device. When the instructions are executed, the first terminal device is configured to perform the method according to the first aspect.

According to a thirteenth aspect, the embodiments of the present disclosure provide a computer-readable storage medium for storing instructions used by the network side device. When the instructions are executed, the network side device is configured to perform the method according to the second aspect.

According to a fourteenth aspect, the embodiments of the present disclosure provide a computer program product including a computer program. When the computer program is run on a computer, the computer is configured to perform the method according to the first aspect.

According to a fifteenth aspect, the embodiments of the present disclosure provide a computer program product including a computer program. When the computer program is run on a computer, the computer is configured to perform the method according to the second aspect.

According to a sixteenth aspect, the embodiments of the present disclosure provide a chip system, including at least one processor and an interface, for supporting the first terminal device in realizing the functions involved in the first aspect, for example, determining or processing at least one of the data and information involved in the method described above. In one possible design, the chip system further includes a memory for storing necessary computer programs and data of the first terminal device. The chip system may include a chip or may include a chip and other discrete devices.

According to a seventeenth aspect, the embodiments of the present disclosure provide a chip system, including at least one processor and an interface, for supporting the network side device in realizing the functions involved in the second aspect, for example, determining or processing at least one of the data and information involved in the method described above. In one possible design, the chip system further includes a memory for storing necessary computer programs and data of the network side device. The chip system may include a chip or may include a chip and other discrete devices.

According to an eighteenth aspect, the embodiments of the present disclosure provide a computer program. When the computer program is run on a computer, the computer is configured to perform the method according to the first aspect.

According to a nineteenth aspect, the embodiments of the present disclosure provide a computer program. When the computer program is run on a computer, the computer is configured to perform the method according to the second aspect.

### BRIEF DESCRIPTION OF THE DRAWINGS

In order to more clearly illustrate the technical solutions in the embodiments of the present disclosure or the background technology, the drawings required for use in the embodiments of the present disclosure or the background technology will be described below.

FIG. 1 is an architecture diagram of a communication system provided by the embodiment of the present disclosure;

FIG. 2 is a flow chart of a data transmission method provided by the embodiment of the present disclosure;

FIG. 3 is a flow chart of another data transmission method provided by the embodiment of the present disclosure;

FIG. 4 is a flow chart of another data transmission method provided by the embodiment of the present disclosure;

FIG. 5 is a flow chart of still another data transmission method provided by the embodiment of the present disclosure;

FIG. 6 is a flow chart of still yet another data transmission method provided by the embodiment of the present disclosure;

FIG. 7 is a structural diagram of a communication device provided by the embodiment of the present disclosure;

FIG. 8 is a structural diagram of another communication device provided by the embodiment of the present disclosure;

FIG. 9 is a schematic diagram of a structure of a chip provided by the embodiment of the present disclosure.

### DETAILED DESCRIPTION

In order to better understand the method and device for data transmission disclosed in the embodiment of the present disclosure, the communication system applicable to the embodiment of the present disclosure is described below.

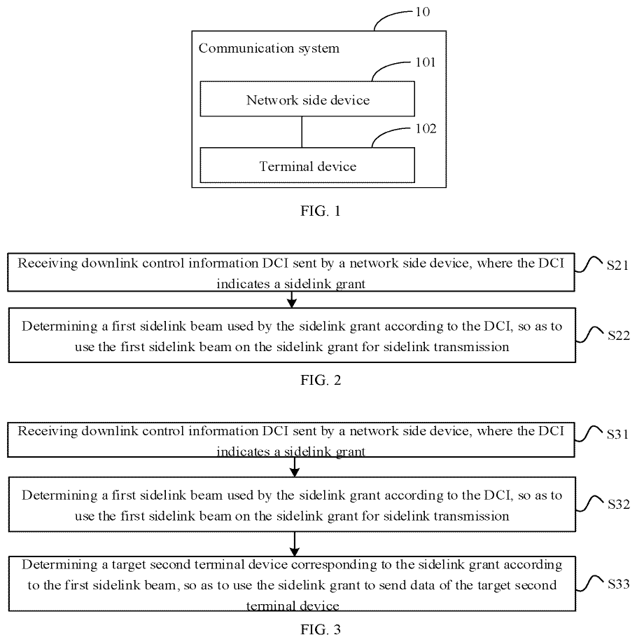

Please refer to FIG. 1, which is a schematic diagram of an architecture of a communication system provided in the embodiment of the present disclosure. The communication system may include but is not limited to a network side device and a terminal device. The number and form of the devices shown in FIG. 1 are only used for example and do not constitute a limitation on the embodiment of the present disclosure. In actual applications, two or more network side devices and two or more terminal devices may be included. The communication system 10 shown in FIG. 1 includes a network side device 101 and a terminal device 102 as an example.

It should be noted that the technical solution of the embodiment of the present disclosure can be applied to various communication systems. For example: long term evolution (LTE) system, fifth generation (5G) mobile communication system, 5G new radio (NR) system, or other future new mobile communication systems. It should also be noted that the side link in the embodiment of the present disclosure can also be called a sidehaul link or a direct link.

The network side device 101 in the embodiment of the present disclosure is an entity on the network side for transmitting or receiving signals. For example, the network side device 101 may be an evolved NodeB (eNB), a transmission reception point (TRP), a next generation NodeB (gNB) in an NR system, a base station in other future mobile communication systems, or an access node in a wireless fidelity (WiFi) system, etc. The embodiments of the present disclosure do not limit the specific technology and specific device form adopted by the base station. The base station provided in the embodiments of the present disclosure may be composed of a central unit (CU) and a distributed unit (DU), where the CU may also be referred to as a control unit. The CU-DU structure may split the base station, such as the protocol layers of the base station, and the functions of some protocol layers are placed in the CU for centralized control, and the functions of the remaining part or all of the protocol layers are distributed in the DU, and the DU is centrally controlled by the CU.

The terminal device 102 in the embodiments of the present disclosure is an entity on the user side for receiving or transmitting signals, such as a mobile phone. The terminal device may also be referred to as a terminal, a user equipment (UE), a mobile station (MS), a mobile terminal (MT), etc. The terminal device may be a car with communication function, a smart car, a mobile phone, a wearable device, a tablet computer (pad), a computer with wireless transceiver function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc. The embodiments of the present disclosure do not limit the specific technology and specific device form adopted by the terminal device.

It can be understood that the communication system described in the embodiments of the present disclosure is to more clearly illustrate the technical solution of the embodiments of the present disclosure, and does not constitute a limitation on the technical solution provided by the embodiments of the present disclosure. It can be known to those skilled in the art that with the evolution of the system architecture and the emergence of new business scenarios, the technical solution provided by the embodiments of the present disclosure is also applicable to similar technical problems.

In order to support direct communication between terminal devices, the sidelink communication mode is introduced, and the interface between terminal devices is PC-5. According to the correspondence between the sending terminal device and the receiving terminal device, three transmission modes are supported on the sidelink: unicast, multicast and broadcast. The sending terminal device sends SCI (Sidelink Control Information) on the PSCCH (physical sidelink control channel) and sends second-stage SCI on the PSSCH (physical sidelink shared channel), where the resource location of the transmission data and the source and destination identifiers are carried. After receiving the SCI, the receiving terminal device determines whether to receive the corresponding data and to which process it corresponds based on the identifiers of the source terminal device and destination terminal device. In the unicast connection, each terminal device corresponds to a destination identifier. In the multicast, each terminal device can belong to one or more groups, and each group corresponds to a destination identifier. In the broadcast, all terminal devices correspond to at least one destination identifier.

Each logical channel has a priority for logical channel scheduling. This priority is configured by the network. The network configures it for a terminal device in a connected state through a dedicated signaling and for a terminal device in an idle state through broadcasting. The network configures a priority for a logical channel according to the QoS (quality of service) of the data carried by the logical channel.

When the terminal device receives a sidelink transmission resource grant (sidelink grant), the terminal device first selects the destination terminal device and uses the terminal device corresponding to the sidelink logical channel with the highest priority as the destination terminal device.

There are two ways to allocate transmission resources in Sidelink communication. One is the network dynamic scheduling method, and the other is a method in which the terminal device autonomously selects from the resource pool broadcast by the network. The dynamic scheduling is that the network dynamically allocates transmission resources on the sidelink to the terminal device based on the cached data reported by the terminal device, while the autonomous selection is that the terminal device randomly selects transmission resources from the resource pool broadcasted by the network or the pre-configured resource pool. The resource pool for the dynamic scheduling method and the resource pool for the autonomous selection method are separate. The resources are uniformly allocated by the base station in the dynamic scheduling. Therefore, a reasonable algorithm can be used to avoid collisions between different terminal devices.

A terminal device may have multiple sidelink transmission beams. When the terminal device transmits sidelink data to different destination terminal devices, different sidelink transmission beams may be used. The sidelink beam used by the destination terminal device may be called the activated sidelink beam of the destination terminal device.

In the related art, when a first terminal device sends sidelink data to different second terminal devices, it may use different sidelink beams. After receiving the sidelink grant, the sidelink data can be accurately transmitted to the second terminal device when it is sent using only the corresponding beam on the sidelink grant. If only the logical channel priority is considered to determine the second terminal device, the transmission beam used by the first terminal device to send data to the second terminal device is inconsistent with the beam corresponding to the sidelink grant, which will cause the second terminal device to be unable to receive the data sent by the first terminal device. This is an urgent problem to be solved.

Based on this, method and device for data transmission are provided in the embodiment of the present disclosure. The terminal device determines the first sidelink beam used by the sidelink grant, so that the first sidelink beam can be used on the sidelink grant to transmit data to the second terminal device, which can avoid data transmission loss or failure.

Method and device for data transmission provided by the present disclosure are described in detail below in conjunction with the accompanying drawings.

Please refer to FIG. 2, which is a flow chart of a data transmission method provided by an embodiment of the present disclosure.

As shown in FIG. 2, the method is executed by a first terminal device, and the method may include but is not limited to the following steps:

S21: Receiving downlink control information DCI sent by a network side device, where the DCI indicates a sidelink grant.

S22: Determining a first sidelink beam used by the sidelink grant according to the DCI, so as to use the first sidelink beam on the sidelink grant for sidelink transmission.

In the embodiment of the present disclosure, the network side device sends DCI (Downlink Control Information) to the first terminal device, where the DCI indicates the sidelink grant.

After the first terminal device receives the DCI sent by the network side device, it can determine the first sidelink beam used by the sidelink grant according to the DCI.

For example, the first terminal device may determine the first sidelink beam used by the sidelink grant indicated by the DCI according to the protocol agreement, or may further determine the first sidelink beam used by the sidelink grant indicated by the DCI according to the indication of the network side device, or may also determine the first sidelink beam used by the sidelink grant indicated by the DCI based on the first terminal device, and so on. The embodiments of the present disclosure do not specifically limit on this.

In the embodiment of the present disclosure, the first terminal device receives the downlink control information DCI sent by the network side device, and determines the first sidelink beam used by the sidelink grant according to the DCI, so that the first sidelink beam can be used on the sidelink grant for sidelink transmission, and the first sidelink beam can be used on the sidelink grant to transmit data to any second terminal device, which can avoid data transmission loss or failure.

It can be understood that the first terminal device can also determine the target second terminal device from multiple second terminal devices to transmit data to the target second terminal device. The target second terminal may also be determined according to the logical channel priority selection method, or may also be determined by other means. In the embodiment of the present disclosure, there is no specific restriction on the determination method of the target second terminal device, but the determination method of the target second terminal device needs to satisfy that the determined target second terminal device can receive data on the first sidelink beam used by the sidelink grant, so as to ensure the accurate transmission of data between the first terminal device and the target second terminal device, and avoid data transmission loss or failure.

By implementing the embodiment of the present disclosure, the first terminal device receives downlink control information DCI sent by the network side device, where the DCI indicates the sidelink grant; the first sidelink beam used by the sidelink grant is determined according to the DCI, so as to use the first sidelink beam on the sidelink grant for sidelink transmission. Thus, the first terminal device can use the first sidelink beam on the sidelink grant to transmit data to the second terminal device, which can avoid data transmission loss or failure.

In some embodiments, the DCI includes a sidelink beam identifier. Determining the first sidelink beam used by the sidelink grant according to the DCI includes determining the first sidelink beam used by the sidelink grant according to the sidelink beam identifier.

In an embodiment of the present disclosure, the first terminal device receives DCI sent by the network side device, where the DCI includes a sidelink beam identifier, and the first terminal device can determine the first sidelink beam used by the sidelink grant according to the sidelink beam identifier.

The sidelink beam identifier can be indicated by TCI (transmission configuration indicator).

In some embodiments, the first terminal device determines the target second terminal device corresponding to the sidelink grant according to the first sidelink beam, so as to use the sidelink grant to send data of the target second terminal device.

In an embodiment of the present disclosure, after the terminal device determines the first sidelink beam used by the sidelink grant, it can also determine the target second terminal device corresponding to the sidelink grant according to the first sidelink beam, so as to use the sidelink grant to send data of the target second terminal device.

The target second terminal device corresponding to the sidelink grant is determined according to the first sidelink beam, and by matching the first sidelink beam with the activated sidelink beams of multiple second terminal devices (sidelink beams used by the second terminal devices), the target second terminal device can be determined.

Alternatively, a part of candidate second terminal devices may be determined from multiple second terminal devices according to the logical channel priority selection method, and further, by matching the first sidelink beam with the activated sidelink beams of the candidate second terminal devices (the sidelink beams used by the second terminal devices), the target second terminal device is determined.

Alternatively, sidelink logical channels with data to be sent and the activated sidelink beams of the corresponding candidate second terminal devices may be determined in advance, and by matching the first sidelink beam with the activated sidelink beams of the candidate second terminal devices (the sidelink beams used by the second terminal devices), the target second terminal device is determined.

Alternatively, a part of the candidate second terminal devices may be determined from multiple second terminal devices according to the logical channel priority selection method, and further, by matching the first sidelink beam with the activated sidelink beams of the candidate second terminal devices (the sidelink beams used by the second terminal devices), the target second terminal device is determined.

Alternatively, the transmission configurations of the sidelink logical channels with data to be sent may also be determined, and the candidate sidelink beams corresponding to the sidelink logical channels with data to be sent may be determined. By matching the first sidelink beam with the candidate sidelink beams, it is determined that the sidelink logical channel for the data to be sent corresponding to the candidate sidelink beam matched with the first sidelink beam performs transmission using the sidelink grant. The sidelink logical channel for the data to be sent corresponding to the candidate sidelink beam matched with the first sidelink beam may preferentially send the data of the high-priority sidelink logical channel according to the priority order when performing transmission using the sidelink grant.

It should be noted that the above embodiments are not exhaustive, but are only illustrative of some embodiments, and the above embodiments may be implemented separately or in combination. The above embodiments are only for illustration and are not for specific limitation to the protection scope of the embodiments of the present disclosure.

In an embodiment of the present disclosure, a first terminal device receives downlink control information DCI sent by a network side device, where the DCI indicates a sidelink grant; a first sidelink beam used by the sidelink grant is determined according to the DCI, and a target second terminal device corresponding to the sidelink grant is determined according to the first sidelink beam, so as to use the sidelink grant to send data of the target second terminal device. Thus, the first terminal device can use the first sidelink beam on the sidelink grant to transmit data to the target second terminal device, thereby avoiding data transmission loss or failure.

In some embodiments, the first terminal device determining the target second terminal device corresponding to the sidelink grant according to the first sidelink beam includes determining activated sidelink beams of second terminal devices; determining a second terminal device corresponding to an activated sidelink beam matched with the first sidelink beam as the target second terminal device.

In an embodiment of the present disclosure, the first terminal device determining the activated sidelink beams of the second terminal devices may be that the first terminal device determining all second terminal devices that establish sidelink connections with the first terminal device, or may be that the first terminal device selecting the second terminal device corresponding to the sidelink logical channel with the highest priority by using the logical channel priority selection method.

It can be understood that the first terminal device determines the second terminal device and can determine the activated sidelink beam of the second terminal device (the sidelink beam used by the second terminal device).

Based on this, when the first terminal device determines the activated sidelink beam of the second terminal device, it can further determine the activated sidelink beam matched with the first sidelink beam, thereby determining that the second terminal device corresponding to the activated sidelink beam matched with the first sidelink beam is the target second terminal device. As a result, the first terminal device can use the first sidelink beam (the activated sidelink beam matched with the first sidelink) on the sidelink grant to transmit data to the target second terminal device, which can avoid data transmission loss or failure.

In some embodiments, the data of the target second terminal device comes from the sidelink logical channel with data to be sent.

In the embodiment of the present disclosure, the first terminal device can use the first sidelink beam (the activated sidelink beam matched with the first sidelink) on the sidelink grant to transmit data to the target second terminal device, where the data of the target second terminal device comes from the sidelink logical channel with data to be sent.

In some embodiments, the sidelink logical channel with data to be sent belongs to the target second terminal device.

In the embodiment of the present disclosure, the sidelink logical channel with data to be sent belongs to the target second terminal device.

In some embodiments, the first terminal device determines the target sidelink logical channel with the highest priority among the sidelink logical channels with data to be sent, so as to use the sidelink grant to send the data of the target second terminal device corresponding to the target sidelink logical channel.

In the embodiment of the present disclosure, the first terminal device may adopt a logical channel priority selection method to select the sidelink logical channel with the highest priority as the target sidelink logical channel, so as to use the sidelink grant to send the data of the target second terminal device corresponding to the target sidelink logical channel. Thus, the first terminal device may use the first sidelink beam (the activated sidelink beam matched with the first sidelink) on the sidelink grant to transmit the to-be-sent data of the target sidelink logical channel to the target second terminal device, thereby avoiding data transmission loss or failure.

In some embodiments, the first terminal device determines the transmission configuration of the target sidelink logical channel, where the transmission configuration indicates the second sidelink beam used by the target sidelink logical channel.

In the embodiment of the present disclosure, the first terminal device may also determine the transmission configuration of the target sidelink logical channel, and the transmission configuration indicates the second sidelink beam used by the target sidelink logical channel.

In some embodiments, the first terminal device determining the transmission configuration of the target sidelink logical channel includes receiving first indication information sent by a network side device or a peer terminal device, where the first indication information indicates the transmission configuration of the target sidelink logical channel; and determining the transmission configuration of the target sidelink logical channel according to the indication information.

In the embodiment of the present disclosure, the first terminal device receives the first indication information sent by the network side device, where the first indication information indicates the transmission configuration of the target sidelink logical channel; and the first terminal device determines the transmission configuration of the target sidelink logical channel according to the indication information.

In the case of receiving the first indication information sent by the network side device, the first indication information may be carried by a system message or an RRC (radio resource control) reconfiguration message.

In the embodiment of the present disclosure, the first terminal device receives the first indication information sent by the peer terminal device, where the first indication information indicates the transmission configuration of the target sidelink logical channel; and the first terminal device determines the transmission configuration of the target sidelink logical channel according to the indication information.

In the case of receiving the first indication information sent by the peer terminal device, the first indication information may be carried by a sidelink RRC reconfiguration message.

In some embodiments, in the case of receiving the first indication information sent by the network side device, it also includes the first terminal device receiving second indication information sent by the network side device, where the second indication information includes a terminal device identifier bound to the transmission configuration, and the transmission configuration indicates the second sidelink beam used by the target sidelink logical channel of the second terminal device corresponding to the terminal device identifier.

In the embodiment of the present disclosure, in the case of receiving the first indication information sent by the network side device, the first terminal device may also receive the second indication information sent by the network side device, where the second indication information includes a terminal device identifier bound to the transmission configuration, and the transmission configuration indicates the second sidelink beam used by the target sidelink logical channel of the second terminal device corresponding to the terminal device identifier.

The first indication information and the second indication information may be sent at the same time, or may be sent separately. In the case of sending at the same time, they may be carried by the same message, or may be carried by two messages separately and sent to the first terminal device at the same time.

In the embodiment of the present disclosure, through the second indication information, the first terminal device may determine that the transmission configuration indicates the second sidelink beam used by the target sidelink logical channel of the second terminal device corresponding to the terminal device identifier.

In some embodiments, the first terminal device determines the target second sidelink beam matched with the first sidelink beam in the second sidelink beams used by the sidelink logical channels with data to be sent among the target sidelink logical channels; determines the target sidelink logical channel corresponding to the target second sidelink beam as the designated sidelink logical channel, so as to use the sidelink grant to send the to-be-sent data of the designated sidelink logical channel.

In the embodiment of the present disclosure, the first terminal device receives the first indication information and the second indication information sent by the network side device, and determines that the transmission configuration indicates the second sidelink beam used by the target sidelink logical channel of the second terminal device corresponding to the terminal device identifier.

Based on this, the first terminal device can determine the sidelink logical channel with the data to be set in the target sidelink logical channels of the second terminal device corresponding to the terminal device identifier, and the target second sidelink beam matched with the first sidelink beam in the second sidelink beams used by it, and further determine the target sidelink logical channel corresponding to the target second sidelink beam as the designated sidelink logical channel, so as to use the sidelink grant to send the to-be-sent data of the designated sidelink logical channel.

In some embodiments, the first terminal device determines the priority ranking of the designated sidelink logical channel, so as to use the sidelink grant to send the to-be-sent data of the designated sidelink logical channel according to the priority ranking.

In the embodiment of the present disclosure, the first terminal device may determine the sidelink logical channel with to-be-sent data in the target sidelink logical channel of the second terminal device corresponding to the terminal device identifier, and the target second sidelink beam in the second sidelink beam matched with the first sidelink beam used by it, and further determine the target sidelink logical channel corresponding to the target second sidelink beam as the designated sidelink logical channel, so as to use the sidelink grant to send the to-be-sent data of the designated sidelink logical channel.

The first terminal device uses the sidelink grant to send the to-be-sent data of the designated sidelink logical channel, and may also predetermine the priority ranking of the designated sidelink logical channel, so as to use the sidelink grant to send the to-be-sent data of the designated sidelink logical channel according to the priority ranking.

In some embodiments, the sidelink logical channel with data to be sent belongs to the target second terminal device.

In the embodiment of the present disclosure, the sidelink logical channel with data to be sent belongs to the target second terminal device.

Please refer to FIG. 3, which is a flowchart of another data transmission method provided by an embodiment of the present disclosure.

As shown in FIG. 3, the method is executed by a first terminal device, and the method may include but is not limited to the following steps:

S31: Receiving downlink control information DCI sent by a network side device, where the DCI indicates a sidelink grant.

S32: Determining a first sidelink beam used by the sidelink grant according to the DCI, so as to use the first sidelink beam on the sidelink grant for sidelink transmission.

The relevant descriptions of S31 and S32 can refer to the relevant descriptions in the above embodiments, which will not be repeated here.

S33: Determining a target second terminal device corresponding to the sidelink grant according to the first sidelink beam, so as to use the sidelink grant to send data of the target second terminal device.

In the embodiment of the present disclosure, after the terminal device determines the first sidelink beam used by the sidelink grant, it can also determine the target second terminal device corresponding to the sidelink grant according to the first sidelink beam, so as to use the sidelink grant to send data of the target second terminal device.

The target second terminal device corresponding to the sidelink grant is determined according to the first sidelink beam, and by matching the first sidelink beam with the activated sidelink beams of multiple second terminal devices (sidelink beams used by the second terminal devices), the target second terminal device can be determined.

Alternatively, a part of candidate second terminal devices may be determined from multiple second terminal devices according to the logical channel priority selection method, and further, by matching the first sidelink beam with the activated sidelink beams of the candidate second terminal devices (the sidelink beams used by the second terminal devices), the target second terminal device is determined.

Alternatively, sidelink logical channels with data to be sent and the activated sidelink beams of the corresponding candidate second terminal devices may be determined in advance, and by matching the first sidelink beam with the activated sidelink beams of the candidate second terminal devices (the sidelink beams used by the second terminal devices), the target second terminal device is determined.

Alternatively, a part of the candidate second terminal devices may be determined from multiple second terminal devices according to the logical channel priority selection method, and further, by matching the first sidelink beam with the activated sidelink beams of the candidate second terminal devices (the sidelink beams used by the second terminal devices), the target second terminal device is determined.

Alternatively, the transmission configurations of the sidelink logical channels with data to be sent may also be determined, and the candidate sidelink beams corresponding to the sidelink logical channel with data to be sent may be determined. By matching the first sidelink beam with the candidate sidelink beams, it is determined that the sidelink logical channel for the data to be sent corresponding to the candidate sidelink beam matched with the first sidelink beam performs transmission using the sidelink grant. The sidelink logical channel for the data to be sent corresponding to the candidate sidelink beam matched with the first sidelink beam may preferentially send the data of the high-priority sidelink logical channel according to the priority order when performing transmission using the sidelink grant.

It should be noted that the above embodiments are not exhaustive, but are only illustrative of some embodiments, and the above embodiments can be implemented separately or in combination. The above embodiments are only for illustration and are not for specific limitation of the protection scope of the embodiments of the present disclosure.

In some embodiments, the first terminal device determining the target second terminal device corresponding to the sidelink grant according to the first sidelink beam includes determining the activated sidelink beams of the second terminal devices; determining a second terminal device corresponding to an activated sidelink beam matched with the first sidelink beam as the target second terminal device.

In an embodiment of the present disclosure, the first terminal device determining the activated sidelink beams of the second terminal devices may be that the first terminal device determining all the second terminal devices that establish sidelink connections with the first terminal device, or may be that the first terminal device selecting the second terminal device corresponding to the sidelink logical channel with the highest priority by using the logical channel priority selection method.

It can be understood that the first terminal device determines the second terminal device and can determine the activated sidelink beam of the second terminal device (the sidelink beam used by the second terminal device).

Based on this, when the first terminal device determines the activated sidelink beam of the second terminal device, it can further determine the activated sidelink beam matched with the first sidelink beam, thereby determining that the second terminal device corresponding to the activated sidelink beam matched with the first sidelink beam is the target second terminal device. As a result, the first terminal device can use the first sidelink beam (the activated sidelink beam matched with the first sidelink) on the sidelink grant to transmit data to the target second terminal device, which can avoid data transmission loss or failure.

In some embodiments, the data of the target second terminal device comes from the sidelink logical channel with data to be sent.

In the embodiment of the present disclosure, the first terminal device can use the first sidelink beam (the activated sidelink beam matched with the first sidelink) on the sidelink grant to transmit data to the target second terminal device, where the data of the target second terminal device comes from the sidelink logical channel with data to be sent.

In some embodiments, the sidelink logical channel with data to be sent belongs to the target second terminal device.

In the embodiment of the present disclosure, the sidelink logical channel with data to be sent belongs to the target second terminal device.

In some embodiments, the first terminal device determines the target sidelink logical channel with the highest priority among the sidelink logical channels with data to be sent, so as to use the sidelink grant to send the data of the target second terminal device corresponding to the target sidelink logical channel.

In the embodiment of the present disclosure, the first terminal device may adopt a logical channel priority selection method to select the sidelink logical channel with the highest priority as the target sidelink logical channel, so as to use the sidelink grant to send the data of the target second terminal device corresponding to the target sidelink logical channel. Thus, the first terminal device may use the first sidelink beam (the activated sidelink beam matched with the first sidelink) on the sidelink grant to transmit data to the target second terminal device, which can avoid data transmission loss or failure.

By implementing the embodiment of the present disclosure, the first terminal device receives downlink control information DCI sent by the network side device, where the DCI indicates the sidelink grant; the first terminal device determines the first sidelink beam used by the sidelink grant according to the DCI, and determines the target second terminal device corresponding to the sidelink grant according to the first sidelink beam, so as to use the sidelink grant to send data of the target second terminal device. Thus, the first terminal device can use the first sidelink beam on the sidelink grant to transmit the to-be-sent data of the designated sidelink logical channel to the target second terminal device, which can avoid data transmission loss or failure.

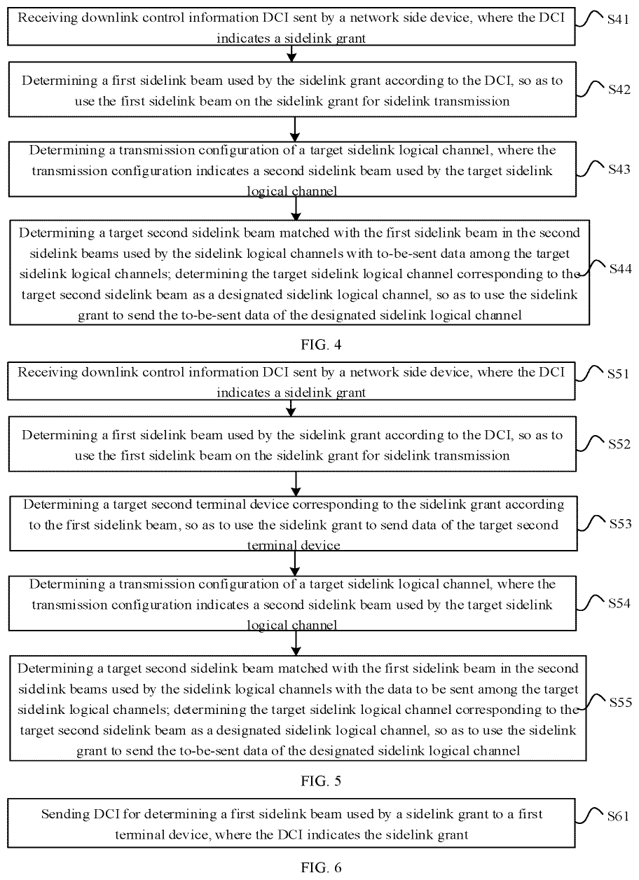

Please refer to FIG. 4, which is a flowchart of another data transmission method provided by the embodiment of the present disclosure.

As shown in FIG. 4, the method is executed by a first terminal device, and the method may include but is not limited to the following steps:

S41: Receiving downlink control information DCI sent by a network side device, where the DCI indicates a sidelink grant.

S42: Determining a first sidelink beam used by the sidelink grant according to the DCI, so as to use the first sidelink beam on the sidelink grant for sidelink transmission.

The relevant descriptions of S41 and S42 can refer to the relevant descriptions in the above embodiments, which will not be repeated here.

S43: Determining a transmission configuration of a target sidelink logical channel, where the transmission configuration indicates a second sidelink beam used by the target sidelink logical channel.

S44: Determining a target second sidelink beam matched with the first sidelink beam in the second sidelink beams used by the sidelink logical channels with to-be-sent data among the target sidelink logical channels; determining the target sidelink logical channel corresponding to the target second sidelink beam as a designated sidelink logical channel, so as to use the sidelink grant to send the to-be-sent data of the designated sidelink logical channel.

In the embodiment of the present disclosure, the first terminal device may also determine the transmission configuration of the target sidelink logical channel, where the transmission configuration indicates the second sidelink beam used by the target sidelink logical channel.

In some embodiments, the first terminal device determining the transmission configuration of the target sidelink logical channel includes receiving first indication information sent by a network side device or a peer terminal device, where the first indication information indicates the transmission configuration of the target sidelink logical channel; and determining the transmission configuration of the target sidelink logical channel according to the indication information.

In the embodiment of the present disclosure, the first terminal device receives the first indication information sent by the network side device, where the first indication information indicates the transmission configuration of the target sidelink logical channel; and the first terminal device determines the transmission configuration of the target sidelink logical channel according to the indication information.

In the case of receiving the first indication information sent by the network side device, the first indication information may be carried by a system message or an RRC reconfiguration message.

In the embodiment of the present disclosure, the first terminal device receives the first indication information sent by the peer terminal device, where the first indication information indicates the transmission configuration of the target sidelink logical channel; and the first terminal device determines the transmission configuration of the target sidelink logical channel according to the indication information.

In the case of receiving the first indication information sent by the peer terminal device, the first indication information may be carried by a sidelink RRC reconfiguration message.

In some embodiments, in the case of receiving the first indication information sent by the network side device, it also includes: the first terminal device receiving second indication information sent by the network side device, where the second indication information includes a terminal device identifier bound to the transmission configuration, and the transmission configuration indicates the second sidelink beam used by the target sidelink logical channel of the second terminal device corresponding to the terminal device identifier.

In the embodiment of the present disclosure, in the case of receiving the first indication information sent by the network side device, the first terminal device may also receive the second indication information sent by the network side device, where the second indication information includes a terminal device identifier bound to the transmission configuration, and the transmission configuration indicates the second sidelink beam used by the target sidelink logical channel of the second terminal device corresponding to the terminal device identifier.

The first indication information and the second indication information may be sent at the same time, or may be sent separately. In the case of sending at the same time, they may be carried by the same message, or may be carried by two messages separately and sent to the first terminal device at the same time.

In the embodiment of the present disclosure, through the second indication information, the first terminal device may determine that the transmission configuration indicates the second sidelink beam used by the target sidelink logical channel of the second terminal device corresponding to the terminal device identifier.

In the embodiment of the present disclosure, the first terminal device receives the first indication information and the second indication information sent by the network side device, and determines that the transmission configuration indicates the second sidelink beam used by the target sidelink logical channel of the second terminal device corresponding to the terminal device identifier.

Based on this, the first terminal device can determine the sidelink logical channel with the data to be set in the target sidelink logical channels of the second terminal device corresponding to the terminal device identifier, and the target second sidelink beam matched with the first sidelink beam in the second sidelink beam used by it, and further determine the target sidelink logical channel corresponding to the target second sidelink beam as the designated sidelink logical channel, so as to use the sidelink grant to send the to-be-sent data of the designated sidelink logical channel.

In some embodiments, the first terminal device determines the priority ranking of the designated sidelink logical channel, so as to use the sidelink grant to send the to-be-sent data of the designated sidelink logical channel according to the priority ranking.

In the embodiment of the present disclosure, the first terminal device may determine the sidelink logical channel with data to be sent in the target sidelink logical channel of the second terminal device corresponding to the terminal device identifier, and the target second sidelink beam in the second sidelink beam matched with the first sidelink beam used by it, and further determine the target sidelink logical channel corresponding to the target second sidelink beam as the designated sidelink logical channel, so as to use the sidelink grant to send the to-be-sent data of the designated sidelink logical channel.

The first terminal device uses the sidelink grant to send the to-be-sent data of the designated sidelink logical channel, and may also predetermine the priority ranking of the designated sidelink logical channel, so as to use the sidelink grant to send the to-be-sent data of the designated sidelink logical channel according to the priority ranking.

In some embodiments, the sidelink logical channel with data to be sent belongs to the target second terminal device.

In the embodiment of the present disclosure, the sidelink logical channel with data to be sent belongs to the target second terminal device.

In the embodiment of the present disclosure, the first terminal device receives downlink control information DCI sent by the network side device, where the DCI indicates the sidelink grant; the first terminal device determines the first sidelink beam used by the sidelink grant according to the DCI, and determines the transmission configuration of the target sidelink logical channel, where the transmission configuration indicates the second sidelink beam used by the target sidelink logical channel; the first terminal device determines the target second sidelink beam matched with the first sidelink beam in the second sidelink beams used by the sidelink logical channels with data to be sent among the target sidelink logical channels; the first terminal device determines the target sidelink logical channel corresponding to the target second sidelink beam to be a designated sidelink logical channel, so as to use the sidelink grant to send the to-be-sent data of the designated sidelink logical channel. Thus, the first terminal device can use the first sidelink beam on the sidelink grant to transmit the to-be-sent data of the designated sidelink logical channel to the second terminal device, which can avoid data transmission loss or failure.

Please refer to FIG. 5, which is a flowchart of another data transmission method provided in the embodiment of the present disclosure.

As shown in FIG. 5, the method is executed by a first terminal device, and the method may include but is not limited to the following steps:

S51: Receiving downlink control information DCI sent by a network side device, where the DCI indicates a sidelink grant.

S52: Determining a first sidelink beam used by the sidelink grant according to the DCI, so as to use the first sidelink beam on the sidelink grant for sidelink transmission.

S53: Determining a target second terminal device corresponding to the sidelink grant according to the first sidelink beam, so as to use the sidelink grant to send data of the target second terminal device.

The relevant descriptions of S51 to S53 can refer to the relevant descriptions in the above embodiments, which will not be repeated here.

S54: Determining a transmission configuration of the target sidelink logical channel, where the transmission configuration indicates a second sidelink beam used by the target sidelink logical channel.

S55: Determining a target second sidelink beam matched with the first sidelink beam in the second sidelink beams used by the sidelink logical channels with the data to be sent among the target sidelink logical channels; determining the target sidelink logical channel corresponding to the target second sidelink beam as a designated sidelink logical channel, so as to use the sidelink grant to send the to-be-sent data of the designated sidelink logical channel.

The relevant descriptions of S54 and S55 can refer to the relevant descriptions in the above embodiments, which will not be repeated here.

In the embodiment of the present disclosure, the first terminal device receives downlink control information DCI sent by the network side device, where the DCI indicates the sidelink grant; the first terminal device determines the first sidelink beam used by the sidelink grant according to the DCI, determines the target second terminal device corresponding to the sidelink grant according to the first sidelink beam, so as to use the sidelink grant to send data of the target second terminal device; the first terminal device determines the transmission configuration of the target sidelink logical channel, where the transmission configuration indicates the second sidelink beam used by the target sidelink logical channel; the first terminal device determines the target second sidelink beam matched with the first sidelink beam in the second sidelink beams used by the sidelink logical channels with data to be sent among the target sidelink logical channels; the first terminal device determines that the target sidelink logical channel corresponding to the target second sidelink beam is a designated sidelink logical channel, so as to use the sidelink grant to send the to-be-sent data of the designated sidelink logical channel. Thus, the first terminal device can use the first sidelink beam on the sidelink grant to transmit the to-be-sent data of the designated sidelink logical channel to the target second terminal device, which can avoid data transmission loss or failure.

Please refer to FIG. 6, which is a flowchart of another data transmission method provided in the embodiment of the present disclosure.

As shown in FIG. 6, the method is executed by a network side device, and the method may include but is not limited to the following steps:

S61: Sending DCI for determining a first sidelink beam used by a sidelink grant to a first terminal device, where the DCI indicates the sidelink grant.

In the embodiment of the present disclosure, the network side device sends DCI (Downlink Control Information) to the first terminal device, where the DCI indicates the sidelink grant.

After the first terminal device receives the DCI sent by the network side device, it can determine the first sidelink beam used by the sidelink grant according to the DCI.

For example, the first terminal device may determine the first sidelink beam used by the sidelink grant indicated by the DCI according to the protocol agreement, or may further determine the first sidelink beam used by the sidelink grant indicated by the DCI according to the indication of the network side device, or may also determine the first sidelink beam used by the sidelink grant indicated by the DCI based on the first terminal device, and so on. The embodiments of the present disclosure do not specifically limit on this.

In the embodiment of the present disclosure, the first terminal device receives the downlink control information DCI sent by the network side device, and determines the first sidelink beam used by the sidelink grant according to the DCI, so that the first sidelink beam can be used on the sidelink grant for sidelink transmission, and the first sidelink beam can be used on the sidelink grant to transmit data to any second terminal device, which can avoid data transmission loss or failure.

It can be understood that the first terminal device can also determine the target second terminal device from multiple second terminal devices to transmit data to the target second terminal device. The target second terminal may also be determined according to the logical channel priority selection method, or may also be determined by other means. In the embodiment of the present disclosure, there is no specific restriction on the determination method of the target second terminal device, but the determination method of the target second terminal device needs to satisfy that the determined target second terminal device can receive data on the first sidelink beam used by the sidelink grant, so as to ensure the accurate transmission of data between the first terminal device and the target second terminal device, and avoid data transmission loss or failure.

In some embodiments, the DCI includes a sidelink beam identifier. Determining the first sidelink beam used by the sidelink grant according to the DCI includes determining the first sidelink beam used by the sidelink grant according to the sidelink beam identifier.

In an embodiment of the present disclosure, the first terminal device receives DCI sent by the network side device, where the DCI includes a sidelink beam identifier, and the first terminal device can determine the first sidelink beam used by the sidelink grant according to the sidelink beam identifier.

The sidelink beam identifier can be indicated by TCI (Transmission Configuration Indicator).

By implementing the embodiment of the present disclosure, the network side device sends the DCI for determining the first sidelink beam used by the sidelink grant to the first terminal device, where the DCI indicates the sidelink grant. Thus, the first terminal device can use the first sidelink beam on the sidelink grant to transmit data to the second terminal device, which can avoid data transmission loss or failure.

In some embodiments, the network side device sends first indication information to the terminal device, where the first indication information indicates the transmission configuration of the target sidelink logical channel, and the transmission configuration indicates the second sidelink beam used by the target sidelink logical channel.

In an embodiment of the present disclosure, a first terminal device receives first indication information sent by a network side device, and the first indication information indicates the transmission configuration of a target sidelink logical channel; and the first terminal device determines the transmission configuration of the target sidelink logical channel according to the indication information.

In the case of receiving the first indication information sent by the network side device, the first indication information can be carried by a system message or an RRC reconfiguration message.

In an embodiment of the present disclosure, a first terminal device receives first indication information sent by a peer terminal device, and the first indication information indicates a transmission configuration of a target sidelink logical channel; and the first terminal device determines the transmission configuration of the target sidelink logical channel according to the indication information.

In the case of receiving the first indication information sent by the peer terminal device, the first indication information can be carried by a sidelink RRC reconfiguration message.

In some embodiments, the network side device sends second indication information to the first terminal device, where the second indication information includes a terminal device identifier bound to the transmission configuration, and the transmission configuration indicates the second sidelink beam used by the target sidelink logical channel of the second terminal device corresponding to the terminal device identifier.

In an embodiment of the present disclosure, in the case of receiving the first indication information sent by the network side device, the first terminal device may also receive the second indication information sent by the network side device, where the second indication information includes a terminal device identifier bound to the transmission configuration, and the transmission configuration indicates the second sidelink beam used by the target sidelink logical channel of the second terminal device corresponding to the terminal device identifier.

The first indication information and the second indication information can be sent at the same time, or can also be sent separately. In the case of sending at the same time, they can be carried by the same message, or can also be carried by two messages separately and sent to the first terminal device at the same time.

In an embodiment of the present disclosure, through the second indication information, the first terminal device can determine that the transmission configuration indicates the second sidelink beam used by the target sidelink logical channel of the second terminal device corresponding to the terminal device identifier.

In the above embodiments provided by the present disclosure, the method provided by the embodiment of the present disclosure is introduced from the perspective of the first terminal device and the network side device respectively. In order to realize the functions in the method provided by the above embodiments of the present disclosure, the first terminal device and the network side device may include a hardware structure and a software module, and realize the above functions in the form of a hardware structure, a software module, or a hardware structure plus a software module. One of the above functions can be executed in the form of a hardware structure, a software module, or a hardware structure plus a software module.

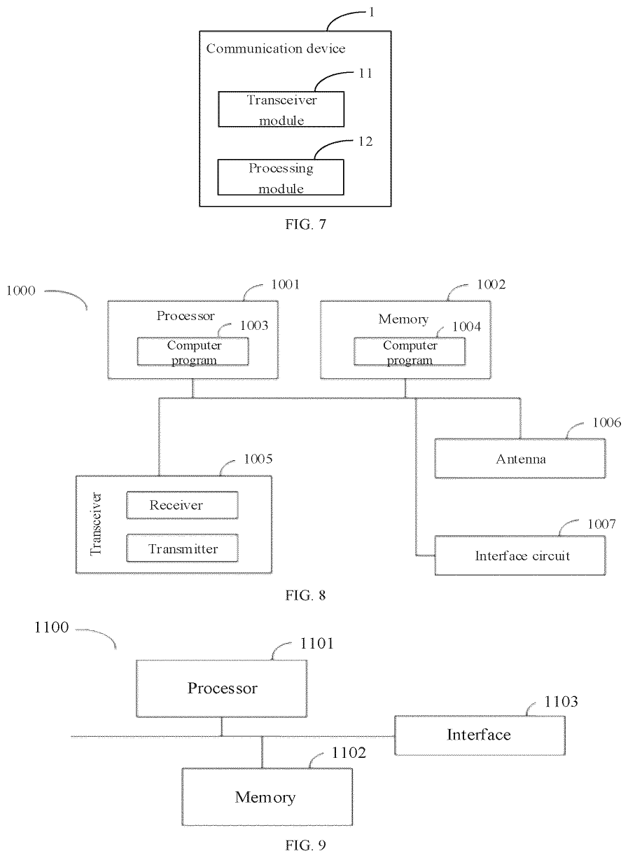

Please refer to FIG. 7, which is a schematic diagram of a structure of a communication device 1 provided in an embodiment of the present disclosure. The communication device 1 shown in FIG. 7 may include a transceiver module 11 and a processing module. The transceiver module may include a sending module and/or a receiving module. The sending module is configured to implement the sending function, the receiving module is configured to implement the receiving function, and the transceiver module may implement the sending function and/or the receiving function.

The communication device 1 may be a first terminal device, or a device in the first terminal device, or a device that can be used with the first terminal device. Alternatively, the communication device 1 may be a network side device, or a device in the network side device, or a device that can be used with the network side device.

The communication device 1 is the first terminal device:

The device includes a transceiver module 11 and a processing module 12.

The transceiver module 11 is configured to receive downlink control information DCI sent by the network side device, where the DCI indicates a sidelink grant.

The processing module 12 is configured to determine a first sidelink beam used by the sidelink grant according to the DCI, so as to use the first sidelink beam on the sidelink grant for sidelink transmission.

A target second terminal device corresponding to the sidelink grant is determined according to the first sidelink beam, so as to use the sidelink grant to send data of the target second terminal device.

In some embodiments, the DCI includes a sidelink beam identifier; the processing module 12 is further configured to determine the first sidelink beam used by the sidelink grant according to the sidelink beam identifier.

In some embodiments, the processing module 12 is further configured to determine activated sidelink beams of second terminal devices; determine that a second terminal device corresponding to an activated sidelink beam matched with the first sidelink beam is a target second terminal device.

In some embodiments, the data of the target second terminal device comes from the sidelink logical channel with data to be sent.

In some embodiments, the processing module 12 is further configured to determine a target sidelink logical channel with the highest priority among the sidelink logical channels with data to be sent, so as to use the sidelink grant to send the data of the target second terminal device corresponding to the target sidelink logical channel.

In some embodiments, the processing module 12 is further configured to determine a transmission configuration of the target sidelink logical channel, where the transmission configuration indicates a second sidelink beam used by the target sidelink logical channel.

In some embodiments, the transceiver module 11 is further configured to receive first indication information sent by a network side device or a peer terminal device, where the first indication information indicates the transmission configuration of the target sidelink logical channel.

The processing module 12 is further configured to determine the transmission configuration of the target sidelink logical channel according to the indication information.

In some embodiments, the transceiver module 11 is further configured to receive second indication information sent by the network-side device, where the second indication information includes a terminal device identifier bound to the transmission configuration, and the transmission configuration indicates the second sidelink beam used by the target sidelink logical channel of the second terminal device corresponding to the terminal device identifier.

In some embodiments, the processing module 12 is further configured to determine the target second sidelink beam matched with the first sidelink beam in the second sidelink beams used by the sidelink logical channels with data to be sent among the target sidelink logical channels; determine the target sidelink logical channel corresponding to the target second sidelink beam as a designated sidelink logical channel, so as to use the sidelink grant to send the to-be-sent data of the designated sidelink logical channel.

In some embodiments, the processing module 12 is further configured to determine the priority ranking of the designated sidelink logical channel, so as to use the sidelink grant to send the to-be-sent data of the designated sidelink logical channel according to the priority ranking.

In some embodiments, the sidelink logical channel with data to be sent belongs to the target second terminal device.

The communication device 1 is a network-side device:

The device includes a transceiver module 11.

The transceiver module 11 is configured to send DCI for determining a first sidelink beam used by a sidelink grant to a first terminal device, where the DCI indicates the sidelink grant.

In some embodiments, the DCI includes a sidelink beam identifier of the first sidelink beam.

In some embodiments, the transceiver module 11 is further configured to send first indication information to the first terminal device, where the first indication information indicates a transmission configuration of the target sidelink logical channel, and the transmission configuration indicates a second sidelink beam used by the target sidelink logical channel.

In some embodiments, the transceiver module 11 is further configured to send second indication information to the first terminal device, where the second indication information includes a terminal device identifier bound to the transmission configuration, and the transmission configuration indicates the second sidelink beam used by the target sidelink logical channel of the second terminal device corresponding to the terminal device identifier.

Regarding the communication device 1 in the above embodiment, the specific manner in which each module performs the operation has been described in detail in the embodiment of the method, and will not be described in detail here.

The communication device 1 provided in the above embodiment of the present disclosure achieves the same or similar beneficial effects as the data transmission method provided in some of the above embodiments, and will not be repeated here.

Please refer to FIG. 8, which is a schematic diagram of a structure of another communication device 1000 provided in an embodiment of the present disclosure. The communication device 1000 can be a network side device, or a first terminal device, or a chip, a chip system, or a processor that supports the network side device to implement the above method, or a chip, a chip system, or a processor that supports the first terminal device to implement the above method. The communication device 1000 can be configured to implement the method described in the above method embodiment, and the details can be referred to the description in the above method embodiment.

The communication device 1000 may include one or more processors 1001. The processor 1001 may be a general-purpose processor or a dedicated processor, etc. For example, it may be a baseband processor or a central processing unit. The baseband processor can be configured to process the communication protocol and communication data, and the central processing unit can be configured to control the communication device (such as a network side device, a baseband chip, a terminal device, a terminal device chip, a DU or a CU, etc.), execute a computer program, and process data of the computer program.

In some embodiments, the communication device 1000 may also include one or more memories 1002, on which a computer program 1004 may be stored, and the memory 1002 executes the computer program 1004 so that the communication device 1000 executes the method described in the above method embodiment. In some embodiments, data may also be stored in the memory 1002. The communication device 1000 and the memory 1002 may be provided separately or integrated together.

In some embodiments, the communication device 1000 may also include a transceiver 1005 and an antenna 1006. The transceiver 1005 may be referred to as a transceiver unit, a transceiver machine, or a transceiver circuit, etc., for implementing a transceiver function. The transceiver 1005 may include a receiver and a transmitter. The receiver may be referred to as a receiving machine or a receiving circuit, etc., for implementing a receiving function; the transmitter may be referred to as a transmitting machine or a transmitting circuit, etc., for implementing a transmitting function.

In some embodiments, the communication device 1000 may also include one or more interface circuits 1007. The interface circuit 1007 is configured to receive code instructions and transmit them to the processor 1001. The processor 1001 runs the code instructions to enable the communication device 1000 to execute the method described in the above method embodiment.

The communication device 1000 is a first terminal device: the transceiver 1005 is configured to execute S21 in FIG. 2; S31 in FIG. 3; S41 in FIG. 4; S51 in FIG. 5; the processor 1001 is configured to execute S22 in FIG. 2; S32 and S33 in FIG. 3; S42 to S44 in FIG. 4; S52 to S55 in FIG. 5.

The communication device 1000 is a network side device: the transceiver 1005 is configured to execute S61 in FIG. 6.

In one implementation, the processor 1001 may include a transceiver for implementing receiving and transmitting functions. For example, the transceiver may be a transceiver circuit, an interface, or an interface circuit. The transceiver circuit, interface, or interface circuit for implementing the receiving and transmitting functions may be separate or integrated. The above-mentioned transceiver circuit, interface or interface circuit can be used for reading and writing code/data, or the above-mentioned transceiver circuit, interface or interface circuit can be used for signal transmission or delivery.

In one implementation, the processor 1001 can store a computer program 1003, and the computer program 1003 runs on the processor 1001, which can enable the communication device 1000 to perform the method described in the above method embodiment. The computer program 1003 may be fixed in the processor 1001, in which case the processor 1001 may be implemented by hardware.

In one implementation, the communication device 1000 may include a circuit, which can implement the functions of sending or receiving or communicating in the above method embodiment. The processor and transceiver described in the present disclosure can be implemented on an integrated circuit (IC), an analog IC, a radio frequency integrated circuit RFIC, a mixed signal IC, an application specific integrated circuit (ASIC), a printed circuit board (PCB), an electronic device, etc. The processor and transceiver can also be manufactured using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication device described in the above embodiments may be a first terminal device or a network side device, but the scope of the communication device described in the present disclosure is not limited thereto, and the structure of the communication device may not be limited to FIG. 8. The communication device may be an independent device or may be part of a larger device. For example, the communication device may be:
(1) an independent integrated circuit IC, or a chip, or a chip system or subsystem;
(2) a set of one or more ICs, in some embodiments, the set of ICs may also include a storage component for storing data or computer programs;
(3) an ASIC, such as a modem;
(4) a module that can be embedded in other devices;
(5) a receiver, a terminal device, an intelligent terminal device, a cellular phone, a wireless device, a handheld device, a mobile unit, a vehicle-mounted device, a network device, a cloud device, an artificial intelligence device, etc.;
(6) others, etc.

For the case where the communication device may be a chip or a chip system, please refer to FIG. 9, which is a structural diagram of a chip provided in an embodiment of the present disclosure.

Chip 1100 includes a processor 1101 and an interface 1103. The number of processors 1101 may be one or more, and the number of interfaces 1103 may be multiple.

For the case where the chip is configured to implement the function of the first terminal device in the embodiment of the present disclosure:

Interface 1103 is configured to receive code instructions and transmit them to the processor.

Processor 1101 is configured to execute code instructions to execute the data transmission method as described in some of the above embodiments.

For the case where the chip is configured to implement the function of the network side device in the embodiment of the present disclosure:

Interface 1103 is configured to receive code instructions and transmit them to the processor.

Processor 1101 is configured to run code instructions to execute the data transmission method as described in some of the above embodiments.

In some embodiments, the chip 1100 also includes a memory 1102, which is configured to store necessary computer programs and data.

Those skilled in the art may also understand that the various illustrative logical blocks and steps listed in the embodiment of the present disclosure may be implemented by electronic hardware, computer software, or a combination of the two. Whether such functions are implemented by hardware or software depends on the specific application and the design requirements of the entire system. Those skilled in the art may use various methods to implement the functions for each specific application, but such implementation should not be understood as exceeding the scope of protection of the embodiment of the present disclosure.

The embodiment of the present disclosure also provides a data transmission system, which includes the communication device as the first terminal device and the communication device as the network side device in the embodiment of FIG. 7 above, or the system includes the communication device as the first terminal device and the communication device as the network side device in the embodiment of FIG. 8 above.

The present disclosure also provides a readable storage medium on which instructions are stored, and when the instructions are executed by a computer, the functions of any of the above-mentioned method embodiments are realized.

The present disclosure also provides a computer program product, which, when executed by a computer, realizes the functions of any of the above-mentioned method embodiments.

In the above-mentioned embodiments, it can be implemented in whole or in part by software, hardware, firmware, or any combination thereof. When implemented by software, it can be implemented in whole or in part in the form of a computer program product. The computer program product includes one or more computer programs. When the computer program is loaded and executed on a computer, the process or function described in the embodiment of the present disclosure is generated in whole or in part. The computer can be a general-purpose computer, a special-purpose computer, a computer network, or other programmable device. The computer program can be stored in a computer-readable storage medium, or transmitted from one computer-readable storage medium to another computer-readable storage medium. For example, the computer program can be transmitted from one website, computer, server, or data center to another website, computer, server, or data center by wired (e.g., coaxial cable, optical fiber, digital subscriber line (DSL)) or wireless (e.g., infrared, wireless, microwave, etc.) means. The computer-readable storage medium may be any available medium that can be accessed by a computer or a data storage device such as a server or a data center that includes one or more available media. The available medium may be a magnetic medium (e.g., a floppy disk, a hard disk, a magnetic tape), an optical medium (e.g., a high-density digital video disc (DVD)), or a semiconductor medium (e.g., a solid state disk (SSD)).

Those skilled in the art can understand that the various digital numbers such as the first and the second involved in the present disclosure are only for the convenience of description, and are not used to limit the scope of the embodiments of the present disclosure, and also indicate the order of precedence.

At least one in the present disclosure can also be described as one or more, and the multiple can be two, three, four or more, which is not limited by the present disclosure. In the embodiments of the present disclosure, for a technical feature, the technical features in the technical feature are distinguished by “first”, “second”, “third”, “A”, “B”, “C” and “D”, etc., and there is no order of precedence or size between the technical features described by the “first”, “second”, “third”, “A”, “B”, “C” and “D”.

The correspondences shown in the tables in the present disclosure can be configured or predefined. The values of the information in each table are only examples and can be configured to other values, which are not limited by the present disclosure. When configuring the correspondence between information and each parameter, it is not necessarily required to configure all the correspondences illustrated in each table. For example, in the table in the present disclosure, the correspondences shown in some rows may not be configured. For another example, appropriate deformation adjustments can be made based on the above table, such as splitting, merging, etc. The names of the parameters shown in the titles of the above tables may also be other names that can be understood by the communication device, and the values or representations of the parameters may also be other values or representations that can be understood by the communication device. When implementing the above tables, other data structures may also be used, such as arrays, queues, containers, stacks, linear lists, pointers, linked lists, trees, graphs, structures, classes, heaps, or hash tables.

The predefinition in the present disclosure may be understood as definition, definition in advance, storage, pre-storage, pre-negotiation, pre-configuration, curing, or pre-burning.

Those skill in the art may realize that the units and algorithm steps of the examples described in the embodiments disclosed herein may be implemented in electronic hardware or in a combination of computer software and electronic hardware. Whether these functions are executed in hardware or software depends on the specific application and design constraints of the technical solution. Professional technicians may use different methods to implement the described functions for each specific application, but such implementation should not be considered to be beyond the scope of the present disclosure.

Those skilled in the art may clearly understand that for the convenience and simplicity of description, the specific working process of the system, device and unit described above may refer to the corresponding process in the aforementioned method embodiment, and will not be repeated here.

The above is only a specific embodiment of the present disclosure, but the protection scope of the present disclosure is not limited thereto. Those skilled in the art who is familiar with the technical field can easily think of changes or substitutions within the technical scope disclosed in the present disclosure, which should be included in the protection scope of the present disclosure. Therefore, the protection scope of the present disclosure should be based on the protection scope of the claims.

1. A data transmission method, performed by a first terminal device, comprising:
receiving downlink control information (DCI) sent by a network side device, wherein the DCI indicates a sidelink grant; and
determining a first sidelink beam used by the sidelink grant according to the DCI, and using the first sidelink beam for sidelink transmission on the sidelink grant.

2. The method according to claim 1, further comprising:
determining a target second terminal device corresponding to the sidelink grant according to the first sidelink beam, and using the sidelink grant to send data of the target second terminal device.

3. The method according to claim 1, wherein the DCI comprises a sidelink beam identifier; wherein determining the first sidelink beam used by the sidelink grant according to the DCI comprises:
determining the first sidelink beam used by the sidelink grant according to the sidelink beam identifier.

4. The method according to claim 2, wherein determining the target second terminal device corresponding to the sidelink grant according to the first sidelink beam comprises:
determining an activated sidelink beam of a second terminal device; and
determining the second terminal device corresponding to the activated sidelink beam matched with the first sidelink beam to be the target second terminal device.

5. The method according to claim 4, wherein data of the target second terminal device comes from a sidelink logical channel with data to be sent.

6. The method according to claim 5, further comprising:
determining a target sidelink logical channel with a highest priority among sidelink logical channels with data to be sent, and using the sidelink grant to send the data of the target second terminal device corresponding to the target sidelink logical channel.

7. The method according to claim 1, further comprising:
determining a transmission configuration of a target sidelink logical channel, wherein the transmission configuration indicates a second sidelink beam used by the target sidelink logical channel.

8. The method according to claim 7, wherein determining the transmission configuration of the target sidelink logical channel comprises:
receiving first indication information sent by the network side device or a peer terminal device, wherein the first indication information indicates the transmission configuration of the target sidelink logical channel; and
determining the transmission configuration of the target sidelink logical channel according to the first indication information.

9. The method according to claim 8, wherein in a case of receiving the first indication information sent by the network side device, the method further comprises:
receiving second indication information sent by the network side device, wherein the second indication information comprises a terminal device identifier bound to the transmission configuration, and the transmission configuration indicates the second sidelink beam used by the target sidelink logical channel of a second terminal device corresponding to the terminal device identifier.

10. The method according to claim 7, further comprising:
determining a target second sidelink beam matched with the first sidelink beam in the second sidelink beams used by sidelink logical channels with data to be sent among the target sidelink logical channels; and
determining the target sidelink logical channel corresponding to the target second sidelink beam to be a designated sidelink logical channel, and using the sidelink grant to send data to be sent of the designated sidelink logical channel,
wherein the sidelink logical channel with the data to be sent belongs to the target second terminal device.

11. The method according to claim 10, further comprising:
determining a priority ranking of the designated sidelink logical channel, and using the sidelink grant to send the data to be sent of the designated sidelink logical channel according to the priority ranking.

12. The method according to claim 5, wherein the sidelink logical channel with the data to be sent belongs to the target second terminal device.

13. A data transmission method, performed by a network side device, comprising:
sending downlink control information (DCI) for determining a first sidelink beam used by a sidelink grant to a first terminal device, wherein the DCI indicates the sidelink grant.

14. The method according to claim 13, wherein the DCI comprises a sidelink beam identifier of the first sidelink beam.

15. The method according to claim 13, further comprising:
sending first indication information to the first terminal device, wherein the first indication information indicates a transmission configuration of a target sidelink logical channel, and the transmission configuration indicates a second sidelink beam used by the target sidelink logical channel.

16. The method according to claim 15, further comprising:
sending second indication information to the first terminal device, wherein the second indication information comprises a terminal device identifier bound to the transmission configuration, and the transmission configuration indicates the second sidelink beam used by the target sidelink logical channel of a second terminal device corresponding to the terminal device identifier.

17-18. (canceled)

19. A communication device, comprising a processor and a memory, wherein a computer program is stored in the memory, and the processor executes the computer program stored in the memory to make the device be configured to:
receive downlink control information (DCI) sent by a network side device, wherein the DCI indicates a sidelink grant; and
determine a first sidelink beam used by the sidelink grant according to the DCI, and using the first sidelink beam for sidelink transmission on the sidelink grant.

20. A communication device, comprising a processor and an interface circuit;
the interface circuit is configured to receive a code instruction and transmit it to the processor;
the processor is configured to run the code instruction to perform the method according to claim 1.

21. (canceled)

22. A communication device, comprising a processor and a memory, wherein a computer program is stored in the memory, and the processor executes the computer program stored in the memory to make the device perform the method according to claim 13.

23. A communication device, comprising a processor and an interface circuit, wherein
the interface circuit is configured to receive a code instruction and transmit it to the processor, and
the processor is configured to run the code instruction to perform the method according to claim 13.
